(19) United States
(12) Patent Application Publication
(10) Pub. No.: US 2024/0381500 A1
(43) Pub. Date: Nov. 14, 2024

(54) METHOD FOR THE TREATMENT OF PRODUCTS IN A MICROWAVE TREATMENT DEVICE AND MICROWAVE TREATMENT DEVICE

(71) Applicant: Muegge GmbH, Reichelsheim (DE)

(72) Inventors: Moritz Johann GORATH, Reichelsheim (DE); Daniel BAARS, Fränkisch-Crumbach (DE); Markus REICHMANN, Michelstadt (DE)

(21) Appl. No.: 18/690,164

(22) PCT Filed: Aug. 15, 2022
(86) PCT No.: PCT/EP2022/072791

§ 371 Date: Mar. 7, 2024

(30) Foreign Application Priority Data
Sep. 10, 2021 (DE) 10 2021 123 499.9

(51) Int. Cl. H05B 6/78

(52) U.S. Cl. CPC H05B 6/782

(57) ABSTRACT

The invention relates to a method for treating products in a microwave treatment device and to a microwave treatment device. The microwave treatment device has at least one treatment chamber and at least two coupling elements. The coupling elements are designed to couple microwaves into the treatment chamber during a treatment step (2) so that a product arranged in the treatment chamber is treated by the microwaves propagating in the treatment chamber. In a characteristic ascertaining step (3), characteristics are detected, wherein a check is carried out on the basis of the characteristics in a checking step (4) in order to determine whether an actual treatment result corresponds to a specified target treatment result.

The invention relates to a method for the treatment of products in a microwave treatment device, wherein the microwave treatment device has at least one treatment chamber and at least two coupling elements, and the coupling elements are configured to couple microwaves into the treatment chamber during a treatment step so that a product arranged in the treatment chamber is treated by the microwaves propagating in the treatment chamber.

It is known that microwaves are suitable for and used in many applications to provide microwave energy in a treatment device that can be used for the treatment of products. For example, a plasma can be generated by the microwave energy and a surface of products can be coated or changed with the help of the plasma. It is also known that microwave energy can be used for heating products. For example, microwaves can be used in the food processing industry to heat, cook, pasteurise or sterilise food or food preparations. In this process, the microwave radiation is absorbed to different extents by different materials with differing microwave absorption coefficients, wherein the molecular rotation of the product is preferably excited and heat is thus generated.

Various exemplary embodiments of microwave treatment devices are known from practice, in which the products are moved by means of a conveying element along a conveying path at a predetermined speed through an inlet opening into a treatment chamber, are treated with microwaves in the treatment chamber and are conveyed out of the treatment chamber again through an outlet opening of the treatment chamber. The inlet opening of the treatment chamber can be arranged at a distance from the outlet opening, or the inlet opening can correspond to the outlet opening. The microwaves required for treatment are usually coupled into the treatment chamber via a suitable microwave guide, so that the product located or moving in the treatment chamber is exposed to microwave radiation during a treatment time in a treatment step.

In many cases, the treatment chamber is configured as a cavity resonator, wherein the geometry of the cavity resonator makes it possible to achieve a radiation distribution in the treatment chamber that is as constant as possible and homogeneous with regard to the intensity distribution along a conveying path of the products in the treatment chamber. Such a design of the microwave treatment device with a treatment chamber makes it possible to achieve uniform microwave distribution in the treatment chamber, but the microwave intensity cannot be adjusted to different products or different product areas in a simple and precise manner. This plays a role in particular in the aforementioned heating or pasteurisation as well as sterilisation of foods or processed foods, wherein due to the different microwave absorption coefficients of the individual foods making up a dish, for example, the individual components of the dish heat up at different rates over the treatment period at a constant microwave power. This can lead to the individual ingredients either not being cooked evenly, or also not having a temperature everywhere that is necessary for pasteurisation or sterilisation, in particular during pasteurisation or sterilisation processes.

Methods known in practice for treating a product with microwave radiation only allow, in the event of a deviation of an actual temperature distribution from a predetermined target temperature distribution, either increasing the treatment duration of the treatment step for subsequent product treatments after the treatment step, or increasing the intensity of the microwave radiation in the treatment chamber for subsequent treatment steps or product batches by a predetermined amount. An individual spatial adjustment of the microwave intensity; for example, in the case of a plurality of products with different cooking times, which are in the same treatment chamber at the same time, or an adjustment of other parameters during the treatment step cannot be carried out as a rule, since the intensity distribution is largely predetermined by the shape of the cavity resonator and cannot be changed without further ado.

It is therefore considered to be an object of the present invention to provide a method in which the quickest possible and most reliable adjustment to a desired treatment intensity and, if necessary, a desired spatial distribution of a treatment intensity on or in the product to be treated is made possible in a simple manner.

The object is achieved in that at least one parameter is collected in a parameter determination step prior to or during a treatment period, and in that it is verified in a verification step on the basis of the at least one parameter whether an actual treatment success corresponds to a predefined target treatment success.

By means of the method according to the invention, it can be determined in the verification step, on the basis of the at least one parameter collected in the parameter determination step, whether the actual treatment success corresponds to a target treatment success. After the verification step, for example, if the result of the verification has been determined, a manual or automatic adjustment of the treatment step can take place during the treatment period, so that the actual treatment success corresponds to the predefined treatment success. The treatment duration corresponds to the period of time during which a product is treated with microwaves in the treatment chamber. In this way, for each product to be treated, it is possible to verify in the verification step whether, for example, the layer thickness of a layer applied to a surface of the product during a plasma treatment corresponds to the specified values, or whether the temperature of a product after the treatment step is sufficiently high and corresponds to the specifications. Thus, when treating food or food preparations, it is possible to ensure that the temperature reached by the product is sufficient to successfully kill any pathogenic germs during pasteurisation or, if necessary, to sterilise the food to increase its shelf life.

In addition to the recording of only one parameter, a plurality of parameters can also be collected simultaneously or consecutively with a time delay. By recording a number of individual temperature values at different spatial positions of a product, for example, a temperature distribution within the product can be collected. This temperature distribution can be collected with a single temperature sensor that can be moved during the verification step, with a number of spatially distributed temperature sensors or, for example, with a thermal imaging camera that is configured to detect and process the infrared radiation emitted by the product. The recording of temperature values with a thermal imaging camera can be either line-shaped or matrix-shaped. As the verification step is carried out early and thus prior to the end of the treatment period for an individual product, an adjustment of the treatment can also be made correspondingly early. If no immediate adjustment of the treatment is made during the treatment period, products or product batches that do not comply with a specified tolerance range in the verification step can be sorted out after the treatment. As this can be collected at an early stage, the number of products to be sorted out can be significantly reduced compared to conventional treatment methods.

However, in the verification step, it can also be evaluated whether a given treatment outcome or other intermediate goal can be achieved with the current treatment parameters used. If it is feared that the desired treatment success would not be achieved with the current treatment parameters, the treatment parameters can be changed during the treatment period to achieve the desired treatment success with the currently treated product.

Furthermore, it is optionally possible that, in the parameter determination step, a plurality of similar parameters is collected and a spatial or temporal distribution of the similar parameters is determined. Similar parameters can be collected successively by one parameter determination device or simultaneously by a plurality of parameter determination devices. Thus, for example, a layer thickness distribution of a coating of the product over the space can be determined. Furthermore, a spatial temperature distribution can also be determined. In addition to a spatial distribution, a temporal change in the collected parameters can also be determined and used to verify the desired treatment success. For example, at the beginning of a treatment period, it is possible to check by multiple successive measurements whether the actual heating of a product at the beginning of the treatment period corresponds to the expected heating and therefore whether the desired treatment success is likely to occur. If necessary, the treatment parameters can be adjusted if the deviation between the actual heating and the expected heating is too great.

In addition, different parameters of a product can be collected or evaluated with one parameter determination device or with multiple parameter determination devices. Here, the different parameters may contain redundant information. In this way, a particularly reliable and less error-prone check can be carried out. It is also possible to verify complex treatment successes by collecting various parameters and to quickly adjust the treatment if necessary.

According to the invention, it is provided that the parameters collected in the parameter determination step are used in an adjustment step to adjust the treatment parameter of the treatment step. After it has been verified in the verification step, on the basis of the collected parameter(s), whether an actual treatment success that has occurred up to that point corresponds to a predetermined target treatment success during the verification step, the treatment parameters of the treatment step can be adjusted on the basis of this information to the conditions and properties of the product to be treated and to other conditions of the system and the environment. By drawing conclusions based on the parameters collected in the parameter determination step, the treatment parameters of the treatment step can be adjusted in real time for the treatment of subsequent product batches or for the product to be treated in order to achieve the best possible adjustment of the treatment parameters in the shortest possible treatment time and thus treatment success.

The method according to the invention also makes it possible, for example, to influence a spatial distribution of the microwaves by using at least two microwave coupling elements that can be operated differently in the treatment chamber and thereby to achieve a constant or another arbitrarily predetermined temperature distribution for products with different microwave absorption coefficients by adapting the microwave intensity precisely to the location. The coupling elements can be horn radiators, coaxial radiators with decoupling elements, antennas or patch antennas. The required different microwave intensity distribution over the treatment area can be achieved by direct irradiation with microwaves or by a targeted destructive or constructive superposition of microwaves in order to avoid the formation of undesired inhomogeneities in the treatment or, when heating a product, the often undesired formation of hot spots or cold spots.

In the parameter determination step, parameters of the product arranged in the treatment chamber or several products arranged one after the other or partially or completely one above the other can be collected simultaneously via a suitable device. Preferably, the temperature distribution of different foods or food preparations arranged on a tray can be collected. The temperature distribution collected in the parameter determination step can be used to draw conclusions about the treatment success and to adjust the treatment parameters in the treatment step on the basis of this. In addition to the temperature distribution, other parameters such as the ambient pressure, the air flow, the arrangement of the products on the conveying element or other factors can also be taken into account and included in the change of the treatment parameters. In addition to achieving treatment success, the method also enables a reduction in waste.

The parameter determination step can be carried out at any time prior to or during the treatment duration of the treatment step, wherein a subsequent adjustment and correction of the treatment parameters within the treatment step is preferably made possible in real time. In this case, the adjustment and correction of the treatment parameters is not limited to a certain number of treatment parameters, but the adjustment can essentially be carried out for any number of treatment parameters during the treatment step, wherein multiple corrections are possible.

In addition to this process monitoring as well as process adjustment in the measurement step, the verification step and the adjustment step, data determined individually for each product can also not only be collected but also stored in a suitable form in order to ensure and document complete documentation and thus a high level of treatment process and product safety.

Preferably, according to the invention it is optionally provided that, in the treatment step, the phase and/or the frequency and/or the amplitude of the microwaves coupled to the coupling element or respectively coupled to the coupling elements is modulated as a treatment parameter. Common methods are configured so that, for example, in the event of a deviation of the actual temperature distribution from the target temperature distribution, a deviation of the coating thickness or the coating quality, the amplitude of the microwave radiation is adjusted at the coupling element used. When using multiple coupling elements or coupling groups consisting of multiple coupling elements in a treatment chamber, the frequency and phase of the microwave can be adjusted at the coupling elements in addition to the amplitude, allowing a precise and finely controllable change of the microwave intensity distribution over the space by adjusting the treatment parameters to achieve the desired treatment outcome. In this process, the intensity distribution of the radiation can be adjusted precisely to the location by selectively superposing the microwaves in the treatment chamber through destructive and constructive interference of the waves.

In addition to adjusting the parameters of the coupled microwaves such as phase, amplitude and frequency, other treatment parameters such as, among others, the air temperature as well as the air flow in the treatment chamber, a belt speed of the conveying element and the pressure conditions prevailing in the treatment chamber can also be adjusted.

According to an advantageous implementation of the inventive idea, it is provided that the product is measured in the parameter determination step during or after a first partial treatment duration of the treatment step, and in that modified treatment parameters are taken as a basis on the basis of the parameter determination step during a second partial treatment duration following the first partial treatment duration. The product to be treated is treated during the first partial treatment duration with values of the treatment parameters, if any, predefined by a user or by a database. In a parameter determination step that is carried out during or after the treatment step and that interrupts the treatment step, desired parameters that are adapted to the product to be treated and are therefore relevant, such as the temperature, the temperature distribution, the pressure conditions, air flows, belt speeds and the treatment time, can be determined. By comparing the target parameters and the actual parameters, a number of treatment parameters can subsequently be adjusted in order to adapt the actual parameters to the target parameters. In the second partial treatment duration, which follows the first partial treatment duration and the parameter determination step, the modified treatment parameters adjusted to the respective situation can be applied. For example, if the desired temperature distribution is not achieved, the procedure of alternating cycles of a first partial treatment duration, recording the parameters in a parameter determination step, and the adjustment of the treatment parameters in the adjustment step for the second partial treatment duration can be repeated until the actual temperature distribution corresponds to the target temperature distribution. In addition to the treatment parameters, the treatment duration can also be adjusted by adjusting the conveying speed of the conveying element or by switching off the conveying element. Furthermore, it is possible that the parameter determination step is carried out during the treatment step and the adjustment of the treatment parameters of the treatment step is carried out during the treatment of the product.

Advantageously, according to the invention it is optionally provided that input parameters are determined in a pre-treatment step carried out prior to the treatment step, wherein the determined input parameters are used to adjust the treatment parameters in the treatment step. Prior to the treatment step, the treatment parameters can be appropriately calculated and selected either by interrogating the treatment parameters with the treatment parameters from a database such as a process recipe, by experience of a user of the microwave treatment device, or by input parameters collected in the pretreatment step. In the pre-treatment step carried out prior to the treatment step, input parameters can be collected via a suitable device or a plurality of suitable devices, via which conclusions can be drawn as to which treatment and/or output parameters can be used to achieve the treatment success in an optimal manner. Through suitably selected initial parameters, the treatment time of the product and the rejection of products due to a possibly faulty or insufficient treatment can be reduced. A plurality of treatment steps can also be carried out in succession, which together result in the desired treatment of the product and specify the treatment duration. The treatment success of a preceding treatment step can then be collected and used to specify suitable treatment parameters for the subsequent treatment step.

According to an advantageous configuration of the inventive concept, it is provided that the input parameters compiled in the pre-treatment step are product-related input parameters determined by measuring the product conditions, and/or environment-related input parameters determined by measuring the environmental conditions, and/or system-related input parameters determined by measuring the system conditions.

Product-related input parameters are input parameters that can be collected by measuring the product. This includes, for example, the geometry or the shape of the product, wherein conclusions can be drawn about the type of product and thus the structure, the material, and the penetration depth of the microwave beams and the absorption properties, based on several specified products via the shaping. Furthermore, the product-related input parameters may include the temperature of the product prior to the treatment step, the arrangement of the product in the treatment chamber, and the number of products in the treatment chamber.

Environment-related input parameters are input parameters that can be collected by measuring the environmental conditions. These include the ambient temperature, the ambient pressure, the composition of the ambient atmosphere when the products are fed into and discharged from the treatment chamber, and the input temperature and/or the input temperature distribution of the products when they are fed in.

System-related input parameters are understood to be parameters that can be collected by measuring or recording a specification of parameters from a database, such as a recipe of the microwave treatment device. These include the type, the reflected power, the arrangement and the possible power at the coupling elements used, the nature of the treatment chamber as well as the interference conditions associated with it, and the structure of the treatment chamber and its reflective properties. Furthermore, the system-related input parameters include the pressure in the treatment chamber, the composition of the treatment chamber atmosphere in order to be able to compensate for an adaptation of the microwaves by absorption at the ambient atmosphere, and intentional or unintentional air movements in the treatment chamber.

It is also possible and optionally provided according to the invention that the coupling element couples microwaves into the cavity in the treatment step only when the product is located in the area of the treatment chamber irradiated by the microwaves. The coupling elements coupling microwaves into the treatment chamber can be arranged in such a way that the individual coupling elements arranged at a distance from one another mainly irradiate a predetermined area and no or only insignificant superposition of the microwaves takes place for the process. With one or a plurality of products located on a conveying element and moving through the treatment chamber, it can thus be achieved that the microwave treatment device can be operated as energy-efficiently as possible by a coupling element only irradiating microwaves onto an area assigned to it when a product is located in this area. Thus, not only can the microwave treatment device be operated in an energy-efficient manner, but the amount of microwave energy can also be reduced, which is not absorbed by a product, therefore reflected in the treatment chamber and possibly damaging the coupling elements upon impact.

It is also possible that a number of coupling elements arranged spatially spaced-apart are individually controlled in the treatment step. By means of an individual and single control of the coupling elements, the microwave intensity in the irradiated area of this coupling element can be specifically adjusted in order to achieve the desired treatment success by the adjustment in case that one coupling element predominantly irradiates a predetermined area and only an insignificant superposition and thus interference of the microwave energy of several coupling elements is to be considered for the process. In the case of an arrangement of the coupling elements with occurring constructive or destructive interference of the emitted microwaves, one or a plurality of coupling elements can be adapted, wherein the adapted coupling element(s) do not have to irradiate the area of the change directly in order to be able to control the spatial distribution of the treatment.

According to a particularly advantageous design of the invention, it is provided that during the treatment step the product and the coupling elements are displaced relative to one another, and in that the product is irradiated with microwaves from a first coupling element in a first partial treatment duration of the treatment step, while the product is irradiated with microwaves from a second and different coupling element from the first one in a subsequent second partial treatment duration. In many cases, it is appropriate for the product to be moved past a plurality of coupling elements arranged along the conveying path, for example on a conveyor belt, during the treatment step. As long as the product is in the near field of a first coupling element, the product is irradiated by microwaves from this first coupling element in a first partial treatment step. Subsequently, in a subsequent second partial treatment step, the product is moved past a second coupling element arranged at a distance from the first and is irradiated by microwaves from this second coupling element. The two coupling elements can each be controlled individually and in particular differently from one another and consequently each can cause a different treatment of the product with the respective irradiated microwaves.

Between the first partial treatment step and the second partial treatment step, a parameter determination step can be carried out to record the treatment success achieved in the first partial treatment step. The subsequent second partial treatment step and the irradiation of the product with microwaves from the second coupling element can then be specified for each product as a function of the parameters determined in the parameter determination step in such a way that a desired and predetermined treatment success occurs. For example, precise heating of an inhomogeneous product can be performed with microwave irradiation, such as a meal consisting of several ingredients and distributed on a tray. After a first partial treatment duration, the heating or temperature already reached is collected for all ingredients or for all areas on the tray, evaluated and then the subsequent second partial treatment duration is specified individually in such a way that the respective desired heating or temperature is reached for all ingredients. It is therefore not necessary that the microwave radiation is changed by a single coupling element. Rather, by using different coupling elements during different partial treatment durations, an individual adjustment of the microwave irradiation of a product can be carried out in a simple manner without great effort.

It is of course possible and advantageous for many applications that a plurality of first coupling elements is operated in the first partial treatment step and a plurality of second coupling elements are also operated in the second partial treatment step. By using a plurality of coupling elements, a large spatial area can be better covered and specifically irradiated with microwaves. It is also conceivable that a targeted superposition of the microwave radiation emitted by a plurality of first or second coupling elements is generated in order to produce a desired intensity distribution of the superposed microwave radiation in a predetermined spatial area within the treatment chamber and, for example, to enable a targeted treatment of a product in this predetermined spatial area.

Depending on the respective field of application of the method according to the invention, it may be provided that the microwaves emitted by the coupling element generate a plasma in the near field of the relevant coupling element. In the near field of a coupling element, feedback of the irradiated microwaves with the coupling element is possible, but there is still no significant interaction with microwaves irradiated from other coupling elements, provided that the microwave energy is consumed by the product in the near field of the coupling element. As plasma generation takes place in the near field of a coupling element, plasma generation is largely independent of superposition with microwaves from other coupling elements and also independent of superposition with microwaves reflected in the treatment chamber from the same coupling element. The treatment chamber therefore does not have to be designed in such a way that suitable resonance conditions prevail within the treatment chamber for a given product. Rather, the treatment chamber can be designed in such a way that no or only slight resonances of the microwaves irradiated via the coupling elements are excited. This greatly facilitates targeted control of the coupling elements and precise specification of the microwaves radiated onto the product via them, as no complex superposition effects and resonances have to be taken into account when controlling the individual coupling elements and the resulting effects of the irradiated microwave radiation on the product.

It can also be provided that a superposition of the microwave radiation from a plurality of coupling elements is predetermined in such a way that an intensity maximum is generated at a desired distance from the individual coupling elements and thereby, for example, a plasma is generated or a particularly effective heating of a product is effected. With a suitable design of the treatment chamber and an arrangement of the coupling elements relative to one another, it can be achieved that the microwave distribution generated by the superposition depends predominantly or almost exclusively on the arrangement of the coupling elements involved and, if applicable, on a product to be treated, and that possible reflections within the treatment chamber or resonance effects generated by the treatment chamber play no or only a minor role for the suitable control of the individual coupling elements. This facilitates a targeted coupling of microwaves and a controlled energy distribution within the treatment chamber and can be used in terms of process technology.

Preferably, it is provided that a product determination is carried out with the aid of a recording device in the pre-treatment step. Product determination means the recognition and identification of a product on a conveying element, for example. Preferably, the product can be determined by means of an optical evaluation with the aid of a camera, wherein the camera can be designed as a line scan camera, for example. A one-dimensional or multi-dimensional marking such as a one-dimensional or two-dimensional barcode or QR code can be applied to a surface of a product or to a carrier carrying the product that contains information about the product that is captured and read by the camera. By determining the product, the product to be treated or several products can be collected and the initial parameters stored for the product can be read out, with which the treatment parameters can be adjusted. In addition to determining the type of product, the orientation of an individual product on the conveying element and/or the orientation of the individual products in relation to each other can also be collected to enable an optimal intensity distribution of the microwaves during the treatment step.

Furthermore, it is possible and optionally provided according to the invention that image recognition is used for product determination. The image recognition is preferably designed in such a way that a product arranged on the conveying element or in the treatment chamber can be recognised via the image recognition. For this purpose, an image of the treatment chamber or a part of the treatment chamber or the conveying element can be recorded via an optical camera. Using a suitable algorithm, the products depicted in the recorded image can be recognised and identified. The data received can be compared with data from a database and the product can be identified if a predefined comparison parameter is exceeded. For this purpose, an edge model can be generated from the recorded image, which can be compared with stored data in a database. Furthermore, the individual pixels that make up the image can also be compared with one another, for example by comparing the relative brightnesses.

When arranging, for example, a plurality of different foods or food preparations on a tray, the type and arrangement of the individual foods relative to one another can be recognised via image recognition in order to adjust the treatment parameters and/or the output parameters accordingly. Image recognition can also be used to check products for possible damage after the treatment step. This verification can preferably be applied after pasteurisation of products, wherein burst or otherwise damaged products can be sorted out.

In an advantageous configuration of the invention, it is provided that an actual temperature distribution and/or a target temperature distribution of the product is determined in the parameter determination step with the aid of the recording device. The recording device can be used to determine a temperature distribution of the product prior to and/or during and/or after the treatment step. The recording device can be designed as an infrared camera that can gather and record the heat distribution of an individual product or a partial area.

In an advantageous implementation of the invention, it is provided that the parameters determined in the parameter determination step and/or the input parameters determined in the pre-treatment step are processed in a processing device and optionally compared with reference data of a reference database. The data collected in the parameter determination step or in the pre-treatment step can be processed in the processing device, allowing appropriate adjustment of the treatment parameters of the treatment step. Here, the database can refer to reference data stored in the database, wherein a suitable correction of the treatment parameters adjusted to the situation can take place.

Advantageously, according to the invention it is optionally provided that the change to the output parameters and/or the output parameters in the change step are determined by artificial intelligence methods. The artificial intelligence can be configured to process and adjust the treatment parameters on the basis of the input parameters and the parameters determined in one or more parameter determination step and to specify an optimal adjustment of the treatment parameters. The adjustment can thus be made in real time. The artificial intelligence may be further configured to monitor a product throughout its passage through the microwave treatment device and to enable treatment success by making appropriate adjustments.

The artificial intelligence has an artificial neural network, or preferably a deep neural network, which is able to record predetermined or measured parameters, process them within the neural network and control the process in order to achieve an optimal adjustment of the treatment parameters in real time and thus the predetermined treatment success. The predetermined or measured parameters may comprise, but are not limited to, parameters of the coupling elements, the microwave, the belt speed, the product temperature, the type of product, the weight of the product, the shape of the product, the air flow and air temperature inside the treatment chamber, the position of the product, the image recognition data and other parameters such as the cooling water flow, the cooling water temperature, the load water flow and load water temperature.

The artificial intelligence can further be configured in such a way that it can independently recognise new food preparations and optimally adjust the treatment parameters in as few steps as possible.

The invention further relates to a microwave treatment device for the treatment of products with microwave radiation, wherein the microwave treatment device has at least one treatment chamber and at least two coupling elements, and the coupling elements are configured to couple microwaves into the treatment chamber so that a product arranged in the treatment chamber is treated by the microwaves propagating in the treatment chamber.

Microwave treatment devices are suitable for treating objects located in the treatment chamber of the microwave treatment device with microwaves by means of coupling elements arranged on the treatment chamber. For example, such equipment is used to heat or pasteurise food or food preparations. Microwave treatment devices are known from the prior art that have an inlet opening and an outlet opening in the treatment chamber, wherein the outlet opening can be the same as the inlet opening, and wherein the product to be treated is conveyed through the treatment chamber arranged on a conveying element at a continuous speed or remains there for a treatment period. The treatment chamber is often designed as a cavity resonator in order to have a microwave intensity that is distributed as homogeneously as possible within the treatment chamber. For example, a plasma can be generated by the microwave energy in the treatment chamber and a surface of products can be coated or changed with the help of the plasma. It is also known that microwave energy can be used for heating products. For example, to compensate for a deviation of an actual temperature distribution from a predetermined target temperature distribution, prior art microwave treatment devices can either increase the treatment time in the treatment step or increase the intensity of the microwave radiation in the treatment chamber by a constant. A spatially precise adjustment of the microwave intensity, for example for food with a different cooking time, or an adjustment of other parameters during the treatment step can regularly not be carried out.

It is therefore considered to be an object of the present invention to configure a microwave treatment device in such a way that the quickest possible and most reliable adjustment to a desired treatment intensity and, if necessary, a desired spatial distribution of a treatment intensity on or in the product to be treated is made possible.

The object is achieved according to the invention in that the microwave treatment device has a recording device, wherein the recording device is designed to record the parameters of the product arranged in the treatment chamber. For example, the recording device can be configured to collect and transmit a temperature distribution of a product. The recording device can be designed as an infrared camera monitoring the treatment chamber or the conveying element, with which the temperature of an object can be collected precisely to the location. The recording device can also be configured to measure the thickness of a coating applied to the product, for example, or to record and evaluate other changes to the surface of the product. The recording device can also have measurement or sensor devices with which system-related parameters can be collected by measuring the device, environment-related parameters can be collected by measuring the environment and product-related parameters can be collected by measuring the product to be treated.

It can optionally be provided that the recording device is a camera, wherein the camera is configured to collect the light spectrum of ultraviolet light and/or visible light and/or infrared light. The camera has a camera body with an image sensor and a lens fixed to the camera body. The camera is arranged to be able to collect light directed from a light source onto the product and/or onto a marking of the product and reflected from the product or from its marking. When using a plurality of light sources, it can be advantageous to use specialised camera or image sensors optimised for a specific wavelength range. The image sensor can be implemented for example, as a CCD sensor or COS sensor with different designs.

According to an advantageous implementation of the inventive concept, it is provided that the camera is connected to a processing device in a signal-transmitting manner, wherein at least one image taken with the camera is stored in the processing device and compared with reference data of a reference database. The processing device is configured to store the at least one image of a product captured by the camera in a format suitable for images in the processing device, to read it out and, if necessary, to forward it via a suitable interface. Furthermore, the at least one image taken 15 with the camera can be stored in a table format after an appropriate evaluation, for example as temperature values. The processing device can, for example, have an optical and/or magnetic memory such as an HDD memory, or a semiconductor memory such as an SSD memory or a flash memory for storing the images. To verify the captured images, the processing device can evaluate the images with an algorithm suitable for this purpose and compare them with reference data in the database. In particular, the database has a database management system as well as a suitably dimensioned data basis, wherein the data basis contains the stored images as well as the reference data, if necessary, also as an image file.

Advantageously, it is optionally provided according to the invention that the microwave treatment device has at least one light source, wherein the light source can be used to illuminate the product. The at least one light source can be implemented as a point or line light source or as a ring light source and is preferably arranged in or on the treatment chamber so that the product arranged in the treatment chamber and to be irradiated can be illuminated and completely illuminated by the at least one light source. The at least one light source is preferably arranged in such a way that the product to be treated is illuminated as completely as possible and from different angles and thus directions. In this way, shadows cast by the product or other components, as well as reflections on a product surface or on an inner wall of the treatment chamber, can be kept to a minimum. This is particularly advantageous if the device has a recording device that is configured to identify or evaluate the product via optical recognition. The at least one light source can also be arranged outside or remote from the treatment chamber, wherein the light emitted by the at least one light source is guided into the treatment chamber via a light guide and is directed there onto the product to be treated. The at least one light source can be realised as an energy-saving LED light source, wherein the light spectrum emitted by the LED light source preferably ranges from infrared to UV light. In this way, for example, a product marked with a UV-active label can be read out and the stored information processed.

According to an advantageous configuration of the invention, it is provided that the microwave treatment device has a conveying device for conveying a product along a conveying path within the treatment chamber. The conveying device can, for example, have a conveyor belt with which the individual products can be conveyed along the conveying path, wherein the conveying path is determined by the course of the conveyor belt within the treatment chamber. Expediently, a conveying speed for products conveyed with it can also be specified via the conveying device and changed as required.

It can also be provided that individual products are first conveyed in one direction along the conveying path and then conveyed back in an opposite direction along the conveying path. In this way, for example, individual products or a number of products can be automatically conveyed into the treatment chamber, treated therein and then conveyed out of the treatment chamber again in the same way. If necessary, the products can also be moved back and forth several times.

The treatment chamber may have an inlet opening and an outlet opening, wherein the outlet opening may be the same as the inlet opening, and wherein the products arranged on a conveying element may be moved along a conveying path into the treatment chamber and after treatment in the reverse direction out of the treatment chamber, or may be moved on the conveying element in a forward-only movement through the treatment chamber. The coupling elements can be arranged adjacent to one another, wherein the coupling elements irradiate a side of the conveying element containing the product, wherein a predetermined microwave intensity distribution can be achieved in the treatment chamber.

In a particularly advantageous manner, it is optionally provided that a number of coupling elements is arranged along a conveying path of the treatment chamber in such a way that only one area of the conveying path can be irradiated with each coupling element. In this way, each coupling element can generate an individual microwave irradiation intensity and thus treat the product located in the relevant area of the conveying path. In different areas of the conveying path, a different irradiation with microwaves can be specified in a simple manner using different coupling elements. The design of the treatment chamber and the arrangement of the individual coupling elements within the treatment chamber is expediently designed and predetermined in such a way that only a slight superposition of the microwave radiation emitted by the various coupling elements and also only a slight or no resonance of the emitted microwave radiation within the treatment chamber occurs.

Low superposition or resonance of the microwave radiation is considered to be radiation distributions of the microwave radiation within the treatment chamber in which, during operation, the intensity of the microwave radiation outside the near field of the respective coupling elements is not intentionally higher than inside the near field of the respective coupling elements.

Preferably, it is provided that an adjustment of a microwave intensity can be made along the conveying path. In this way, an individually predefinable treatment of the product can be effected in a simple manner during transport along the conveying path.

The recording device can appropriately be arranged between coupling elements spaced along the conveying path. After a treatment with microwaves has been carried out with one or more first coupling elements along the conveying path upstream of the recording device during a first partial treatment duration, at least one parameter can be collected during a further transport of the product past the recording device and the irradiation of the product during a subsequent second partial treatment duration with the second coupling elements arranged along the conveyor section downstream of the recording device can be carried out individually adjusted depending on the at least one determined parameter.

For the coupling of the microwave radiation, the coupling elements can be designed, for example, as horn radiators arranged on the outside of the treatment chamber, which radiate microwaves into the treatment chamber through a quartz glass window. Furthermore, the coupling elements can be coaxial conductors with decoupling elements projecting into the treatment chamber. However, according to a particularly advantageous embodiment of the invention, it is provided that the coupling elements are designed as patch antenna groups with a number of radiating elements, wherein the individual radiating elements can preferably be individually controlled and operated.

Furthermore, it is optionally provided according to the invention that a plurality of coupling elements is arranged spatially spaced apart from one another transverse to the conveying path. Thus, a plurality of products arranged next to one another or partially or completely on top of one another on the conveying element can be treated at the same time. In this way, more products per time unit or products with larger dimensions can be treated than would be the case with a sole arrangement of individual coupling elements along the conveying path. Furthermore, a plurality of coupling elements arranged transversely to the conveying path enable a compact design of the microwave treatment device, since the distance of the coupling elements from the conveyor belt can be kept small and yet a predetermined microwave distribution and intensity can be achieved in the treatment chamber. In this way, for example, a tray with various foods can be heated in an optimum manner.

It is also possible and optionally provided according to the invention that a microwave trap module is arranged at the start of the conveying path and at the end of the conveying path, wherein the microwave trap module is configured to reduce or prevent microwave radiation emerging from the microwave treatment device by destructive interference. The microwave trap module can have a reflection device, which reflects microwaves at the inlet opening and/or at the outlet opening back into the next treatment chamber. Furthermore, the microwave trap module may have an absorption device, which is arranged to absorb microwave radiation escaping from the at least one treatment chamber and thus to prevent microwave radiation from escaping from the microwave treatment device.

In the event that no product is located in the treatment chamber, the inlet opening and the outlet opening can also be closed with an electrically conductive, electromagnetically impermeable and/or absorbent flap to prevent microwaves from escaping from the treatment chamber.

Preferably, it is provided that the device has an operating device, wherein the operating device is configured to display treatment parameters and/or output parameters and/or to preset them via the operating device. The operating device is configured to display all the values and parameters required for the operation of the microwave treatment device. In addition to the current treatment parameters, the set output parameters and the measured input parameters, this also includes the storage and logging of target parameters such as the target temperature, the current number of products to be treated, start values and intermediate values of output parameters, input parameters and treatment parameters, heating curves, power curves, deviations of the actual temperature distribution from the target temperature distribution, and other parameters. The operating device can also be configured such that values such as the target temperature distribution can be specified directly via the operating device or with a further device connected to the operating device. The operating device can be implemented as a touch-sensitive display in the form of a touch display.

According to an advantageous design of the inventive concept, it is optionally provided that the microwave treatment device is designed and configured such that a plasma can be generated in the treatment chamber with the microwave radiation irradiated thereinto via the at least two coupling elements. The microwave treatment device designed according to the invention can be used for controlled generation of a plasma and thus for targeted and individual treatment of a product with the aid of a plasma. The plasma can only be generated in the near field of a coupling element. It is also conceivable that the plasma is generated by superposing the microwaves radiated simultaneously by a plurality of coupling elements. By arranging plurality of or many coupling elements within the treatment chamber or along a conveyor section in the treatment chamber, the plasma generation can be easily adjusted to different products and controlled or regulated in such a way that a predeterminable treatment of the products can be effected with high precision and repeatability.

Furthermore, it is possible and optionally provided according to the invention that the device can be operated with a method according to any one of claims 1 to 17.

In the following, some exemplary embodiments of the invention are explained in more detail, which are shown in the drawing. In the drawing:

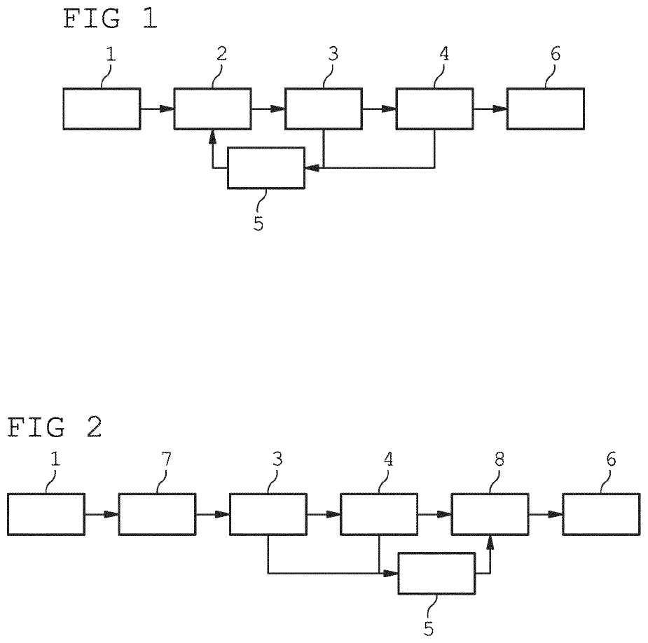

FIG. 1 shows a schematic representation of a method for the treatment of products in a microwave treatment device,

FIG. 2 shows a schematic representation of an alternatively performed method for the treatment of products in a microwave device,

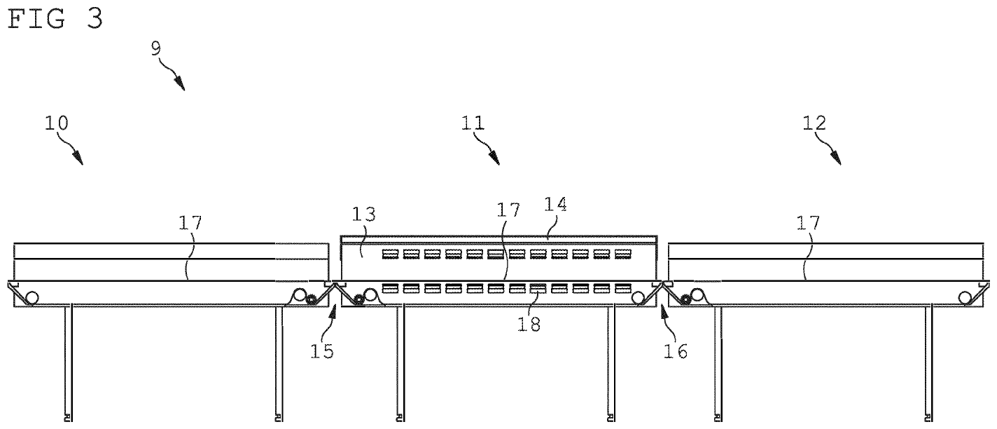

FIG. 3 shows a schematic sectional view along a conveying path through a modularly constructed microwave treatment device consisting of an input module, a process module and an output module,

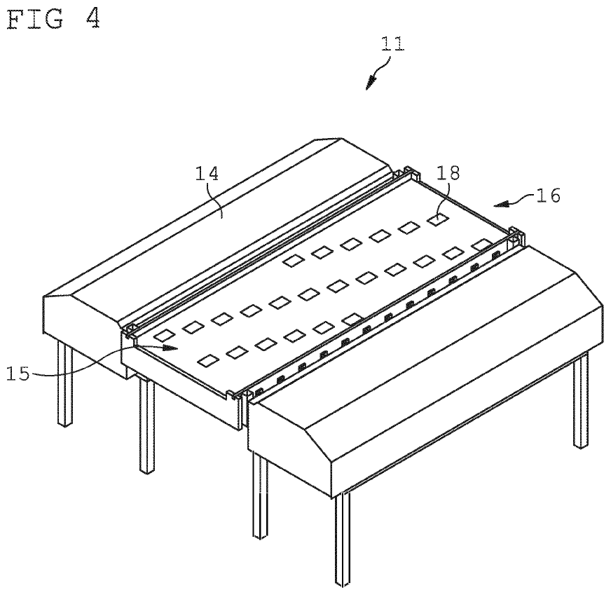

FIG. 4 shows a schematic sectional view from above of the microwave treatment device shown in FIG. 3, and

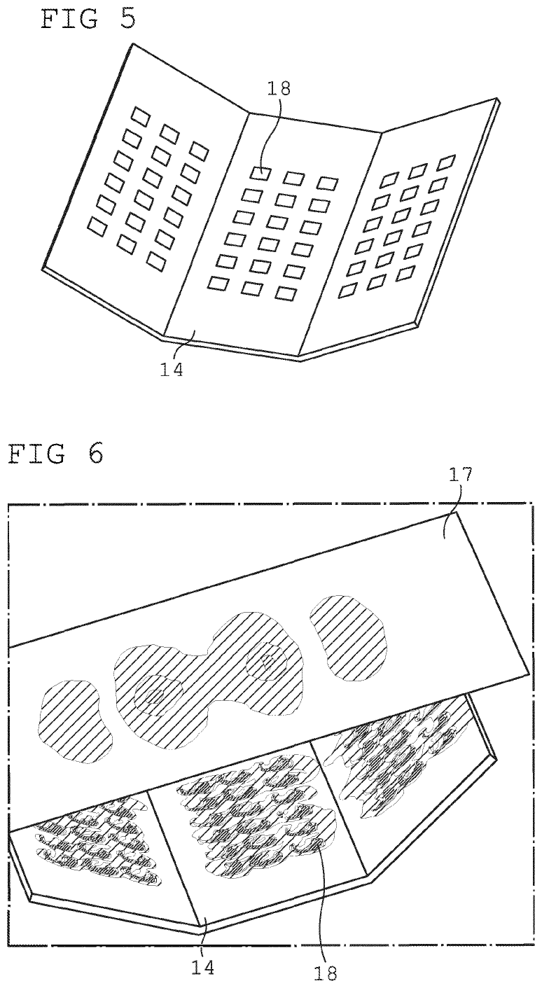

FIG. 5 shows an arrangement of coupling elements according to the invention on a housing designed as patch antennas, and

FIG. 6 shows the arrangement of FIG. 5 with a schematic view of the microwave intensity distribution on a conveying element.

FIG. 1 shows a schematic representation of the method for the treatment of products in a microwave treatment device. Here, the products to be treated with microwaves are moved via a conveying element into a treatment chamber of the microwave treatment device, wherein the products are irradiated with microwaves by coupling elements arranged in the treatment chamber and are thus treated. The microwave treatment device is suitable for heating or pasteurising foods introduced into the treatment chamber on a tray, for example, in order to adjust an actual temperature distribution of the foods as closely as possible to a predetermined target temperature distribution.

In a pre-treatment step 1, product-related, system-related and environment-related input parameters are determined by measuring values or reading out previously defined values, for example. With the help of the input parameters, which include information on the number of coupling elements, their reflected power, a belt speed, a temperature distribution of the product to be treated, the ambient pressure and an air flow, treatment parameters can be adjusted in a treatment step 2 following the pre-treatment step 1, so that the products to be treated receive an optimal treatment with microwaves.

In the treatment step 2, the input parameters determined in the pre-treatment step 1 are used to adjust the treatment parameters. After the treatment step 2, a parameter determination step 3 is performed, wherein parameters are determined in the parameter determination step 3. In a verification step 4 following the parameter determination step 3, it is estimated whether a treatment success can be achieved and/or has already been achieved on the basis of the treatment parameters used. If the temperature falls below a tolerance limit in the verification step 4, the collected parameters of the parameter determination step 3 are processed in an adjustment step 5 and returned to the treatment step 2, wherein the treatment parameters are adjusted on the basis of the parameters obtained in the parameter determination step 3 for subsequent products until, for example, the actual temperature distribution of the product corresponds to the target temperature distribution and the treatment success occurs. If the tolerance limit is complied with in verification step 4, the method according to the invention is terminated in an end step 6 following the verification step 4 and further treatments of products with the determined treatment parameters are carried out.

FIG. 2 shows an alternative configuration of the method according to the invention. Here, a pre-treatment step 1 is followed by a first partial treatment duration 7 in which the product is treated. Parameters are determined in the subsequent parameter determination step 3, wherein in a verification step 4 following the parameter determination step 3 it is verified whether a treatment success can be achieved and/or has already been achieved on the basis of the treatment parameters used. If the tolerance limit is not reached in the verification step 4, the treatment parameters can be adjusted in the adjustment step 5 for a second partial treatment duration 8 of the product.

FIG. 3 shows a modularly constructed microwave treatment device 9 consisting of an inlet module 10, a process module 11 and an outlet module 12. The process module 11 has a housing 14 surrounding a treatment chamber 13. An inlet opening 15 connected to the treatment chamber 13 and an outlet opening 16 are arranged on each of two opposite end faces of the process module 11. The process module 11 further has a conveyor element 17 in the form of a conveyor belt, wherein products can be conveyed by means of the conveyor belt through the inlet opening 15 into the treatment chamber 13 and subsequently after treatment through the outlet opening 16 out of the treatment chamber 13. A number of rows with a number of microwave-radiating coupling elements 18 designed as patch antennas are arranged on an inner wall of the treatment chamber 13, wherein the product arranged in the treatment chamber 13 is irradiated and treated via the microwaves.

FIG. 4 shows a schematic sectional view from above of the microwave treatment device 9 shown in FIG. 3, wherein the conveying element 17 is not shown for the sake of clarity.

In the inlet module 10 and the outlet module 12 in FIG. 3 have a shape similar to that of the process module 11 with a housing surrounding an interior space and a conveying element 17 arranged in the interior space. The products are moved into the process module 11 via the inlet module 10 and moved out of the process module 11 via the outlet module 12.

In the process module 11, a number of coupling elements 18 are arranged in the treatment chamber 13 in such a way that a width of the conveying element 17 can be completely covered with the spatial detection range of the respective near fields of the individual coupling elements 18, and a product conveyed on the conveying element 17 through the treatment chamber 13 can be treated and, for example, heated in a controlled manner with the microwave radiation emitted by the individual coupling elements 18 by selectively controlling the individual coupling elements 18.

FIG. 5 shows a schematic view of a part of the housing 14 of the treatment chamber 13, wherein a deviating arrangement of a plurality of coupling elements 18 is shown as an example. On an inner wall of the housing 14, coupling elements 18 are arranged in three coupling element groups, each in a plurality of rows adjacent to one another. Each coupling element 18 is designed as a patch antenna. The microwave radiation emitted by each individual coupling element 18 can be individually specified in terms of amplitude and phase.

FIG. 6 shows a possible intensity distribution of the superposed microwave radiation within the treatment chamber 13 for the arrangement of the coupling elements 18 shown in FIG. 5. The intensity distribution of the microwave radiation emitted by the coupling elements 18 designed as patch antennas at the coupling elements 18 as well as the microwave intensity in an area on the conveying element 17 are shown schematically. The arrangement of the individual coupling elements 18 and their parameters are selected in such a way that a spatially adjusted and non-homogeneous microwave intensity distribution can be achieved.

In the illustrations of FIGS. 1 to 6, only individual elements of the same type are marked with a reference characters as an example.

### LIST OF REFERENCE CHARACTERS

1 Pre-treatment step
2 Treatment step
3 Measurement step
4 Verification step
5 Adjustment step
6 End step
7 First partial treatment duration
8 Second partial treatment duration
9 Microwave treatment device
10 Input module
11 Process module
12 Output module
13 Treatment chamber
14 Process module housing
15 Inlet opening
16 Outlet opening
17 Conveying element
18 Coupling elements

1. Method for the treatment of products in a microwave treatment device (9), wherein the microwave treatment device (9) comprises at least one treatment chamber (13) and at least two coupling elements (18) and the coupling elements (18) are configured to couple microwaves into the treatment chamber (13) during a treatment step (2) so that a product arranged in the treatment chamber (13) is treated by the microwaves propagating in the treatment chamber (13), wherein, in a parameter determination step (3), prior to or during the treatment duration, at least one parameter is collected, and wherein in a verification step (4) it is verified on the basis of the at least one 15 parameter, whether an actual treatment success corresponds to a predefined target treatment success.

2-17. (canceled)

18. Microwave treatment device (9) for the treatment of products with microwave radiation, wherein the microwave treatment device (9) has at least one treatment chamber (9) and at least two coupling elements (18) and the coupling elements (18) are configured to couple microwaves into the treatment chamber (13) so that a product arranged in the treatment chamber (13) is treated by the microwaves propagating in the treatment chamber (13), wherein, the device has a recording device, wherein the recording device is configured to record parameters of the product arranged in the treatment chamber (13).

19-29. (canceled)

30. Method according to claim 1, wherein in the parameter determination step (3), a plurality of similar parameters are collected and a spatial or temporal distribution of the similar parameters is determined, and/or in that, in the parameter determination step (3), a plurality of different parameters are determined, and/or in that the parameters collected in the parameter determination step (3) are used in an adjustment step (5) to adjust the treatment parameter of the treatment step (2).

31. Method according to claim 1, wherein in the treatment step (2), the phase and/or the frequency and/or the amplitude of the microwaves respectively coupled to the coupling elements (18) is modulated as a treatment parameter, and/or in that the product is measured in the parameter determination step (3) during or after a first partial treatment duration (7) of the treatment step (2), and in that modified treatment parameters are taken as a basis on the basis of the parameter determination step (3) during a second partial treatment duration (8) following the first partial treatment duration (7).

32. The method according to claim 1, wherein input parameters are determined in a pre-treatment step (1) carried out prior to the treatment step (2), wherein the determined input parameters are used to adjust the treatment parameters in the treatment step (2), preferably, wherein the input parameters compiled in the pre-treatment step (1) are product-related input parameters determined by measuring the product conditions, and/or environment-related input parameters determined by measuring the environmental conditions, and/or system-related input parameters determined by measuring the system conditions.

33. The method according to claim 1, wherein the coupling element (18) couples microwaves into the treatment chamber (13) in the treatment step (2) only when the product is located in the area of the treatment chamber (13) irradiated by the microwaves.

34. The method according to claim 1, wherein a number of coupling elements (18) arranged spatially spaced-apart are individually controlled in the treatment step (2), and/or in that during the treatment step (2) the product and the coupling elements (18) are displaced relative to one another, and in that the product is irradiated with microwaves from a first coupling element (18) in a first partial treatment duration (7) of the treatment step (2), while the product is irradiated with microwaves from a second and different coupling element (18) from the first one in a subsequent second partial treatment duration (8).

35. The method according to claim 1, wherein in the treatment step (2), each coupling element (18) is individually controlled in such a way that the microwaves emitted by the coupling element (18) generate a plasma in the near field into the far field of the relevant coupling element (18).

36. The method according to claim 1, wherein a product determination is carried out with the aid of a recording device in the pre-treatment step (1), preferably, wherein image recognition is used for product determination.

37. The method according to claim 1, wherein an actual temperature distribution and/or a target temperature distribution of the product is determined in the parameter determination step (3) with the aid of the recording device.

38. The method according to claim 1, wherein the parameters determined in the parameter determination step (3) and/or the input parameters determined in the pretreatment step (1) are processed in a processing device and optionally compared with reference data of a reference database.

39. The method according to claim 1, wherein changes to the output parameters and/or the output parameters in the change step are determined by artificial intelligence methods.

40. The microwave treatment device (9) according to claim 18, wherein the recording device is a camera, wherein the camera is configured to record the light spectrum of ultraviolet light and/or visible light and/or infrared light.

41. The microwave treatment device (9) according to claim 18, wherein the camera is connected to a processing device in a signal-transmitting manner, wherein at least one image taken with the camera is stored in the processing device and compared with reference data of a reference database.

42. The microwave treatment device (9) according to claim 18, wherein the device has at least one light source, wherein the light source can be used to illuminate the product.

43. The microwave treatment device (9) according to claim 18, wherein the microwave treatment device (9) has a conveying device for conveying a product along a conveying path within the treatment chamber (13).

44. The microwave treatment device (9) according to claim 18, wherein the microwave treatment device (9) has a plurality of coupling elements (18) arranged along a conveying path of the treatment chamber (13) in such a way that only one area of the conveying path can be irradiated with each coupling element (18), preferably, wherein the coupling elements (18) can be controlled in such a way that an adjustment of a microwave intensity can be made along the conveying path, and/or wherein a plurality of coupling elements are arranged spatially spaced apart from one another transverse to the conveying path.

45. The microwave treatment device (9) according to claim 44, wherein a microwave trap module is arranged at the start of the conveying path and at the end of the conveying path, wherein the microwave trap module is configured to reduce or prevent microwave radiation emerging from the treatment chamber (13) or from the microwave treatment device (9) by destructive interference.

46. The microwave treatment device (9) according to claim 18, wherein the microwave treatment device (9) has an operating device, wherein the operating device is configured to display treatment parameters and/or output parameters and/or to preset them via the operating device, and/or in that the microwave treatment device (9) is designed and configured such that a plasma can be generated in the treatment chamber (13) with the microwave radiation irradiated via the at least two coupling elements (18).

47. The microwave treatment device (9) according to claim 18, wherein the microwave treatment device (9) can be operated with a method according to claim 1.
